(19) United States
(12) Patent Application Publication
(10) Pub. No.: US 2008/0197781 A1
(43) Pub. Date: Aug. 21, 2008

(54) Visual Feedback For Remote Controlled Light Devcies

(75) Inventor: Christoph Dobrusskin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,710

(22) PCT Filed: Jul. 17, 2006
(86) PCT No.: PCT/IB2006/052431

§ 371 Date: Jan. 15, 2008

(30) Foreign Application Priority Data
Jul. 20, 2005 (EP) 05106627.2
Jan. 23, 2006 (EP) 06100703.5

(51) Int. Cl. H05B 37/02

(52) U.S. Cl. 315/149

(57) ABSTRACT

The present invention relates to a remote controlled light device (100) comprising a light emitting element (112), which light device is arranged to, in response to a control signal, adjust a property of the light emitting element (112). Additionally, the present invention relates to a remote controlled lighting system and a method of providing feedback, in response to a control signal for adjustment of a property of the light device, to an operator of a remote controlled light device (100). There is provided a remote controlled light device (100) comprising a light emitting element (112), which light device is arranged to provide, in response to a control signal, an adjustment of a first property of the light emitting element (112) and a temporary change of a second property of the light emitting element (112), and wherein the change of the second property is communicated as a feedback signal to an operator of the light device (100).

The present invention relates to a remote controlled light device comprising a light emitting element, which light device is arranged to, in response to a control signal, adjust a property of the light emitting element. Additionally, the present invention relates to a remote controlled lighting system, a set of control electronics and a method of providing feedback, in response to a control signal for adjustment of a property of the light device, to an operator of a remote controlled light device.

The market of lighting devices or systems is increasingly moving away from the manufacturing of light bulbs towards the provision of complete lighting solutions. This shift is supported by technology developments and trends, such as usage of LED's as an alternative to traditional light sources. These new technology developments in their turn create new opportunities for using light sources. One important issue when providing lighting solutions is how to design intuitive and easily-understood interfaces with which the user can control the properties of the lighting device.

Light sources, such as traditional light bulbs, energy saving lamps, LED-based lamps and halogen lamps etc., are increasingly designed to be able to have a remote control controlling one or more of their properties, such as color, intensity, focus, degree of diffusion or programming status. When using a remote control an operator is able to change the properties of the light source. The properties of the light source may also be changed according to a predetermined or programmed path. The changes induced by the operator or the predetermined path are sometimes barely visible, or not visible at all to the operator. For example, subtle color shifts may hardly be noticeable, and changes in remote control programming might not be visible at all. In the past, small colored lights such as LED's have been included in the light source to indicate when an operator sends an remote controlled signal to the light source in order to change a property of the light source. This, however, has the disadvantage that only custom-made, non-standard light sources can be used. An inclusion of visual means of feedback, e.g. LED's, in the light source itself is impractical as it is situated very close to a potentially bright and blinding light source, or possibly totally obscured by a lamp shade.

US 2003/0107888 discloses a remote-control modular lighting system utilizing a directional wireless remote control for the selective adjustment and programming of individual lighting modules. Individual lighting modules may be selected for adjustment by momentarily pointing the remote control at the lighting module to be adjusted. Subsequent adjustments may be done without aiming at the lamp, allowing the operators attention to be on the subject being lit. For home or retail applications, control functions may include aiming of the light, switching on and off the light, and dimming. An indicator lamp, on the module selected, lights up to show that the module is ready to accept omni-directional remote control commands. In US 2003/0107888 it is described that the remote controlled lighting system comprises humanly perceivable response indicator means for responding to reception of a pre-determined information signal from said wireless remote control. Lighting modules may also be controlled as a group or individually. Different groups of lights may be defined within the remote, and lights may be members of multiple groups.

A problem in the prior art is that an operator is given insufficient guidance in order to perceive the response provided by the indicator means.

An object of the invention is to alleviate the problems of prior art.

This object is met by the invention as set forth in the appended independent claims.

In a first aspect of the invention, there is provided a remote controlled light device comprising a light emitting element, which light device is arranged to provide, in response to a control signal, an adjustment of a first property of the light emitting element and a temporary change of a second property of the light emitting element, and wherein the change of the second property is communicated as a feedback signal to an operator of the light device.

A second aspect of the invention relates to a method for providing a feedback signal, in response to a control signal for adjustment of a first property of a light emitting element, which method comprises the steps of: receiving the control signal to change a first property of the light emitting element; temporarily changing a second property of the light emitting element, whereby the change of the second property is communicated as a feedback signal to a sender of the control signal; and adjusting the first property of the light emitting element according to the control signal.

An idea of the invention is to utilize properties, such as luminance (brightness), of a light device for providing visual (optical) feedback means and to provide a method for indication of reception and execution of a remote control signal. The light device is provided with control electronics and a communication interface for receiving control signals. Further, the light device is arranged to perform actions that are defined by the remote control signal. When receiving a control signal, the light device provides a visual feedback signal to the operator by temporarily changing the properties of the light device to a degree that is visible to the operator. This change may possibly be exaggerated to emphasize it to the operator. Then, the control electronics set the controlled property according to the control signal being received. The actions according to the above are performed due to the control of the properties of the light device, thus allowing the operator to receive feedback whether a remote controlled induced change of properties has taken place, and to visually locate the light device or the light source that has been affected. It is to be understood that the order of the steps of sending the audible feedback signal and changing the property may be interchangeable. Hence, these steps may be performed simultaneously or after/before each other.

In a first embodiment of the device according to invention, there is provided a remote controlled light device, wherein the first and second property of the light emitting element are the same property. This has the advantage of indicating, by means of the feedback signal, to the operator which property is being changed.

In a second embodiment of the device of the invention, there is provided a remote controlled light device, wherein the first property of the light emitting element is different from the second property. In a situation where the property to be changed is very difficult to perceive, this is advantageous. The temporary change in property acts as a feedback signal.

Advantageously, the feedback signal is arranged to be a change in color, intensity, focus, degree of diffusion, direction, light pattern or modulation of the light source or a combination thereof. A change in direction of light emitted from the light device may imply that the light emitted from the light device temporarily illuminates another object or surface. A light pattern is attained by projecting different images onto a surface or an object. Additionally, a light pattern may also be attained as a result of narrowing or widening the light cone of the light device. A change in modulation of the light source may for example imply different frequencies of flashing (twinkling, blinking), and not only discrete on/off-sequences are to be considered. Continuously varying (decreasing and/or increasing repeatedly) a property of the light source may also provide a modulated feedback signal. The skilled man realizes that some or all of the above properties may be combined in order to achieve a change, which is used as a feedback signal.

Preferably, the remote controlled light device is arranged such that the feedback signal is different for different control signals to the light device. This leads to be possibility of customizing the feedback signal such that, e.g. an increase yields an exaggerated increase in intensity, whereas e.g. a decrease yields an exaggerated decrease in intensity.

In another embodiment, there is provided a remote controlled light device, wherein the feedback signal is adjustable by the operator. In this manner it is possible for an operator to adjust the feedback signal such that it is easily perceivable.

In still a further embodiment, there is provided a remote controlled light device, wherein the feedback signal is adjustable according to a programmed schedule. This embodiment has the advantage of enabling personalized setups of the feedback signals. Moreover, it enables the remote controlled light device to use different schemes at different times of the day. For example, during the bright hours of the day a shift in intensity may be unsuitable, and instead, a change in color is used as feedback signal and during the night a change in intensity is easily perceivable (but changes in colors are not).

In yet a further embodiment of the present invention, there is provided a lighting system, comprising at least two remote controlled light devices according to the invention, wherein the visual feedback signal is different from one light device to another light device.

In yet still a further embodiment of the invention, there is provided a set of control electronics, for example comprising controls for controlling components as TV, audio, heating apparatus, said set comprises at least one remote controlled light device according to the invention. The advantage being the controll is standardized within the set, thus simplifying the of use of controlling the components comprised in said set.

Further features of, and advantages with, the present invention will become apparent when studying the appended claims and the following description. Those skilled in the art realize that different features of the present invention can be combined to create embodiments other than those described in the following.

The invention will be more apparent from the accompanying drawing, which is provided by way of non-limiting example and on which:

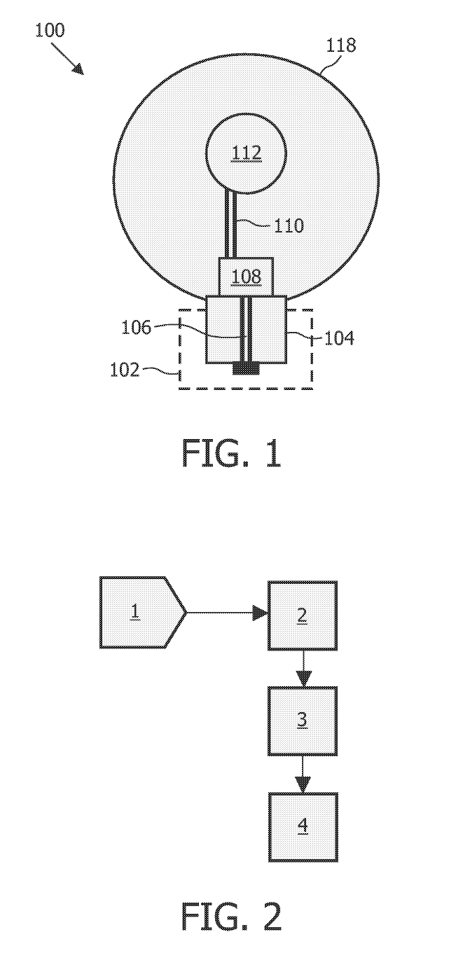

FIG. 1 is a cross-sectional side view of the remote controlled light device according to the invention; and

FIG. 2 shows a typical flow diagram of the method according to the invention.

FIG. 1 shows an example of a light device 100 according to an embodiment of the invention. The light device 100 comprises a light emitting element 112, a first set of connections 110, control electronics 108, a second set of connections 106, a connecting element 104 and, possibly, a housing 118. The light emitting element 112 is connected to the control electronics 108 via the first set of connections 110. The control electronics is connected to the connecting element via the second set of connections 106. The connecting element 104 is connected to a socket 102 that provides energy to the light device. An operator is able to, by means of using a remote control (not shown), change the properties of the light device. A control signal is sent from the remote control to the control electronics, which then execute a control protocol according to FIG. 2.

In FIG. 2 there is shown a typical flow diagram of a method according an embodiment of the present invention. The intended, possibly subtle change in property of the light device is temporarily exaggerated to indicate a remote controlled (RC) change to the operator. In FIG. 2, the light device property that is controlled is brightness. Steps 1-4 described in FIG. 2 may be defined as follows. Initially, the light device may for instance emit light of very low brightness. In step 1, an operator changes, by means of using a remote control, the brightness of the light device, such as changing to “standard/normal” brightness. In step 2, the control electronics receive the RC signal and interpret the signal in order to change the brightness according to the operator's command. In step 3, the light device performs an exaggerated change of the brightness, such as a temporary change to very bright light, and a feedback signal is hence communicated to the operator. This temporary change is normally less than one minute and preferably from a fraction of a second up to 15 seconds. In step 4, the light device is set to the brightness intended by the operator, i.e. the “normal” brightness mentioned in connection to step 2. Hence, the light device emits, by means of an adjustment provided by the remote control, light of “normal” brightness, which is the brightness of the light device that the operator intended.

In another embodiment of the invention, a different property than the property to actually be controlled is changed and fed back to the operator in step 4. For example, instead of performing an exaggerated change of the brightness, a temporary change in light color is performed, while the property to be controlled still is brightness. The man skilled in the art realizes that the subject-matter of this particular embodiment may be combined with the embodiment previously described.

In a further example, an operator is able to select one light device out of a number of light devices. The operator is selecting a light device and receives feedback from the light device for acknowledging the choice by means of a visual feedback signal originating from the light emitting element of the light device itself. Then, when the operator has selected a light device, it is operated as described above.

It should be noted that visual feedback means may be combined with audible means of feedback. Audible feedback means is described in the non-published patent application EP05106628.0, which is hereby incorporated by reference.

Even though the invention has been described with reference to specific examples thereof, many different alterations, modifications and the like will become apparent for those skilled in the art. The described examples are therefore not intended to limit the scope of the invention, as defined by the appended claims.

1. A remote controlled light device (100) comprising a light emitting element (112), which light device (100) is arranged to provide, in response to a control signal from a remote control, an adjustment of a first property of the light emitting element (112) and a temporary change of a second property of the light emitting element (112), wherein said temporary change of the second property is communicated as a feedback signal to an operator of the light device (100).

2. The remote controlled light device (100) according to claim 1, wherein said first and second property of the light emitting element (112) are the same property.

3. The remote controlled light device (100) according to claim 1, wherein said first property of the light emitting element (112) is different from the second property.

4. The remote controlled light device (100) according to claim 1, wherein said feedback signal is arranged to be a change in color, intensity, focus, degree of diffusion, direction, light pattern or modulation of the light source or a combination thereof.

5. The remote controlled light device (100) according to claim 1, wherein said feedback signal is arranged to be different for different control signals to the light device.

6. The remote controlled light device (100) according to claim 1, wherein said feedback signal is arranged to be adjustable by said operator.

7. The remote controlled light device (100) according to claim 1, wherein said feedback signal is arranged to be adjustable according to a programmed schedule.

8. The remote controlled light device (100) according to claim 1, wherein said feedback signal is arranged to be combined with an audible feedback signal.

9. A remote controlled lighting system, wherein said remote controlled lighting system comprises at least two remote controlled light devices (100) according to claim 1.

10. The remote controlled lighting system according to claim 9, wherein said feedback signal is different from one light device to another light device.

11. A set of control electronics, wherein said set of control electronics comprises at least one remote controlled light device (100) according to claim 1.

12. A method for providing a feedback signal, in response to a control signal for adjustment of a first property of a light emitting element (112), which method comprises the steps of:
receiving said control signal to change a first property of the light emitting element (112);
temporarily changing a second property of the light emitting element (112), whereby the change of the second property is communicated as a feedback signal to a sender of the control signal; and
adjusting the first property of the light emitting element (112) according to said control signal.

13. The method according to claim 12, wherein the sender is an operator, which method further comprises the step of:
allowing the operator to adjust the feedback signal.

14. The method according to claim 12 further comprising the step of:
adjusting the feedback signal according to a programmed schedule.

15. The method according to claim 12 further comprising the step of:
selecting, at said sender, one light device out of a plurality of light devices, preferably before said light emitting element receives said control signal to change a first property of the light emitting element (112).
